(19) United States
(12) Patent Application Publication
(10) Pub. No.: US 2020/0338795 A1
(43) Pub. Date: Oct. 29, 2020

(54) INJECTION MOLDED CONTAINER ARTICLES AND METHODS

(71) Applicant: PACTIV LLC, Lake Forest, IL (US)

(72) Inventors: Timothy David McCulley, Richmond Hill (CA); Ludmila Rozenberg, Thornhill (CA)

(73) Assignee: PACTIV LLC, Lake Forest, IL (US)

(21) Appl. No.: 16/397,794

(22) Filed: Apr. 29, 2019

(51) Int. Cl. B29C 45/00; B29C 45/26; B65D 1/22; B65D 43/02

(52) U.S. Cl. CPC B29C 45/0025; B29C 45/26; B29C 45/0046; B29L 2031/712; B65D 43/0206; B29C 2045/0039; B65D 1/22

(57) ABSTRACT

Injection molded container article including a center portion having an outer perimeter. The center portion has a central flow leader defined therein, the central flow leader having a central flow leader thickness. A side wall portion extends from the outer perimeter to an outer rim portion. The center portion and the side wall portion together define a container space having a volume. The side wall portion includes a plurality of side wall flow leaders and a plurality of side wall panels extending between adjacent flow leaders and having side wall panel thickness less than the central flow leader thickness. Each side wall flow leader has a side wall flow leader thickness greater than the side wall panel thickness, and each flow leader extends between the central flow leader and the outer rim portion. Method of making the injection molded container article also provided.

### BACKGROUND OF THE DISCLOSED SUBJECT MATTER

### Field of the Disclosed Subject Matter

The disclosed subject matter relates to injection molded container articles, such as a base or lid of a container.

### Description of the Related Art

Plastic containers are often used due to their durability and lightweight nature. A wide variety of suitable plastic containers are commercialized for various uses. For example, polypropylene is often used to form containers, which are inexpensive, recyclable and manufacturable in large quantities using various techniques, including injection molding or the like.

Injection molded container articles and containers formed therefrom can be used for a variety of perishable and nonperishable products, such as hot and cold food products. Often such articles and containers can be used in “take out” containers and the like. Customers and producers alike increasingly prefer plastic container articles of reduced cost and weight.

The use of injection molded containers and articles is well known. Such articles are often formed by injecting softened or molten material, such as plastic, into a mold cavity having a substantially similar shape as that of the desired article. However, the manufacture of injection molded container articles having reduced part thickness or gauge can result in articles with undesirable characteristics. For example, as part thickness of the desired finished article and corresponding thickness of the injection molding cavity is reduced, the flow of molten material throughout the mold cavity becomes more difficult and can be disrupted. Such disruption can result in, for example, formation of voids, or areas with insufficient material in the finished article. Additionally, such flow disruptions can result in areas of low temperature or pressure within the mold cavity, which can result in a finished article with undesirable performance characteristics caused by, for example, weld or knit lines in the finished article where two low fronts of molten material meet. Furthermore, as a finished article continues to cool after removal from the mold cavity, internal stresses can develop in the article. Such stresses can cause the article to bend or deform, particularly at areas of reduced part thickness. As such, there continues to be a need for improved injection molded container articles with reduced weight and part thickness and methods of manufacturing such articles.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly described in the written description and claims hereof, as well as from the appended drawings.

To achieve these and other advantages, and in accordance with the purpose of the disclosed subject matter, as embodied and broadly described, the disclosed subject matter includes an injection molded container article. The injection molded container article generally includes a center portion having an outer perimeter. The center portion has a central flow leader defined therein, the central flow leader having a central flow leader thickness. The injection molded container article further includes a side wall portion extending from the outer perimeter of the center portion to an outer rim portion. The center portion and the side wall portion together define a container space having a volume.

The side wall portion includes a plurality of side wall flow leaders and a plurality of side wall panels. Each side wall panel extends between adjacent side wall flow leaders and has a side wall panel thickness less than the central flow leader thickness. Each side wall flow leader has a side wall flow leader thickness greater than the side wall panel thickness, and each side wall flow leader extends between the central flow leader and the outer rim portion.

In accordance with another aspect of the disclosed subject matter, a method of making an injection molded container article is provided. The method generally includes providing a mold configured to form a container article. The mold includes a center portion having an outer perimeter, the center portion having a central flow leader defined therein. The central flow leader has a central flow leader thickness. The mold further includes a side wall portion extending from the outer perimeter of the center portion to an outer rim portion. The center portion and the side wall portion together define a container space having a volume. Additionally, the side wall portion includes a plurality of side wall flow leaders and a plurality of side wall panels. Each side wall panel extending between adjacent side wall flow leaders and having a side wall panel thickness less than the central flow leader thickness. Each side wall flow leader has a side wall flow leader thickness greater than the side wall panel thickness. Each side wall flow leader extends between, and is in fluid communication with, the central flow leader and the outer rim portion.

The method further includes injecting molten material into the mold proximate the central flow leader. The molten material is first directed from the central flow leader along the plurality of side wall flow leaders to fill the outer rim portion, and the molten material backfills the side wall panels between the plurality of side wall flow leaders.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the containers and methods of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1 is a plan view of an exemplary embodiment of an injection molded container article in the form of a rectangular base for purpose of illustration, in accordance with the disclosed subject matter.

FIG. 2A is a front cross-sectional view of the exemplary injection molded container article of FIG. 1 taken along line 2A-2A as referenced in FIG. 1.

FIG. 2B is a partial detail view of the front cross-sectional view of FIG. 2A as indicated by broken line 2B as referenced in FIG. 2A.

FIG. 3 is a side cross-sectional view of the exemplary injection molded container article of FIG. 1 taken along line 3-3 as referenced in FIG. 1.

FIG. 4 is a plan view of another exemplary embodiment of an injection molded container article in the form of a rectangular lid for purpose of illustration, in accordance with the disclosed subject matter.

FIG. 5A is a front cross-sectional view of the exemplary injection molded container article of FIG. 4 taken along line 5A-5A as referenced in FIG. 4.

FIG. 5B is a partial detail view of the front cross-sectional view of FIG. 5A as indicated by broken line 5B as referenced in FIG. 5A.

FIG. 6A is a side cross-sectional view of the exemplary injection molded container article of FIG. 4 taken along line 6A-6A as referenced in FIG. 4.

FIG. 6B is a partial detail view of the side cross-sectional view of FIG. 6A as indicated by broken line 6B as referenced in FIG. 6A.

FIG. 7 is a perspective view of an exemplary container comprising the exemplary injection molded container article of FIG. 1 and the exemplary injection molded container article of FIG. 4 in a closed condition.

FIG. 8 is a plan view of another exemplary embodiment of an injection molded container article in the form of a circular base for purpose of illustration, in accordance with the disclosed subject matter.

FIG. 9A is a side cross-sectional view of the exemplary injection molded container article of FIG. 8 taken along line 9A-9A as referenced in FIG. 8.

FIG. 9B is a partial detail view of the side cross-sectional view of FIG. 9A as indicated by broken line 9B as referenced in FIG. 9A.

FIG. 10A is a side cross-sectional view of the exemplary injection molded container article of FIG. 8 taken along line 10A-10A as referenced in FIG. 8.

FIG. 10B is a partial detail view of the side cross-sectional view of FIG. 10A as indicated by broken line 10B as referenced in FIG. 10A

FIG. 11 is a plan view of another exemplary embodiment of an injection molded container article in the form of a circular lid for purpose of illustration in accordance with the disclosed subject matter.

FIG. 12A is a side cross-sectional view of the exemplary injection molded container article of FIG. 11 taken along line 12A-12A as referenced in FIG. 11.

FIG. 12B is a partial detail view of the side cross-sectional view of FIG. 12A as indicated by broken line 12B as referenced in FIG. 12A.

FIG. 13A is a partial side cross-sectional view of the exemplary injection molded container article of FIG. 11 taken along line 13A-13A as referenced in FIG. 11.

FIG. 13B is a partial side cross-sectional view of the exemplary injection molded container article of FIG. 11 taken along line 13B-13B as referenced in FIG. 11.

FIG. 14 is a perspective view of an exemplary container comprising the exemplary injection molded container article of FIG. 8 and the exemplary injection molded container article of FIG. 11 in a closed condition.

FIG. 15A is a table depicting thickness, weight, and top load crush resistance performance measurements of exemplary injection molded container articles in accordance with the disclosed subject matter having a substantially round shape in plan view and configured to form a container base.

FIG. 15B and FIG. 15C are tables depicting thickness, weight, and top load crush resistance performance measurements of comparative container articles having substantially similar size, shape, and construction to the exemplary container articles of FIG. 15A but without flow leaders.

FIG. 16A is a table depicting thickness, weight, and top load crush resistance performance measurements of exemplary injection molded container articles in accordance with the disclosed subject matter having a substantially round shape in plan view and configured to form a container lid.

FIG. 16B and FIG. 16C are tables depicting thickness, weight, and top load crush resistance performance measurements of comparative container articles having substantially similar size, shape, and construction to the exemplary container articles of FIG. 16A but without flow leaders.

FIG. 17A is a table depicting thickness, weight, and top load crush resistance performance measurements of exemplary injection molded container articles in accordance with the disclosed subject matter having a substantially round shape in plan view and configured to form a container base.

FIG. 17B and FIG. 17C are tables depicting thickness, weight, and top load crush resistance performance measurements of comparative container articles having substantially similar size, shape, and construction to the exemplary container articles of FIG. 17A but without flow leaders.

FIG. 18A is a table depicting thickness, weight, and top load crush resistance performance measurements of exemplary injection molded container articles in accordance with the disclosed subject matter having a substantially round shape in plan view and configured to form a container lid.

FIG. 18B and FIG. 18C are tables depicting thickness, weight, and top load crush resistance performance measurements of comparative container articles having substantially similar size, shape, and construction to the exemplary container articles of FIG. 18A but without flow leaders.

FIG. 19A is a table depicting thickness, weight, and top load crush resistance performance measurements of exemplary injection molded container articles in accordance with the disclosed subject matter having a substantially rectangular shape in plan view and configured to form a container base.

FIG. 19B is a table depicting thickness, weight, and top load crush resistance performance measurements of comparative container articles having substantially similar size, shape, and construction to the exemplary container articles of FIG. 19A but without flow leaders.

FIG. 20A is a table depicting thickness, weight, and top load crush resistance performance measurements of exemplary injection molded container articles in accordance with the disclosed subject matter having a substantially rectangular shape in plan view and configured to form a container lid.

FIG. 20B is a table depicting thickness, weight, and top load crush resistance performance measurements of comparative container articles having substantially similar size, shape, and construction to the exemplary container articles of FIG. 20A but without flow leaders.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The articles and methods presented herein can be used for the packaging, transport, storage, commercialization, and consumption of a wide variety of heated or non-heated foodstuffs and other products. The disclosed subject matter is particularly suited for injection molded plastic containers or the like.

In accordance with the disclosed subject matter herein, the injection molded container article generally includes a center portion having an outer perimeter. The center portion has a central flow leader defined therein, the central flow leader having a central flow leader thickness. The injection molded container article further includes a side wall portion extending from the outer perimeter of the center portion to an outer rim portion. The center portion and the side wall portion together define a container space having a volume.

The side wall portion includes a plurality of side wall flow leaders and a plurality of side wall panels. Each side wall panel extends between adjacent side wall flow leaders and has a side wall panel thickness less than the central flow leader thickness. Each side wall flow leader has a side wall flow leader thickness greater than the side wall panel thickness, and each side wall flow leader extends between the central flow leader and the outer rim portion.

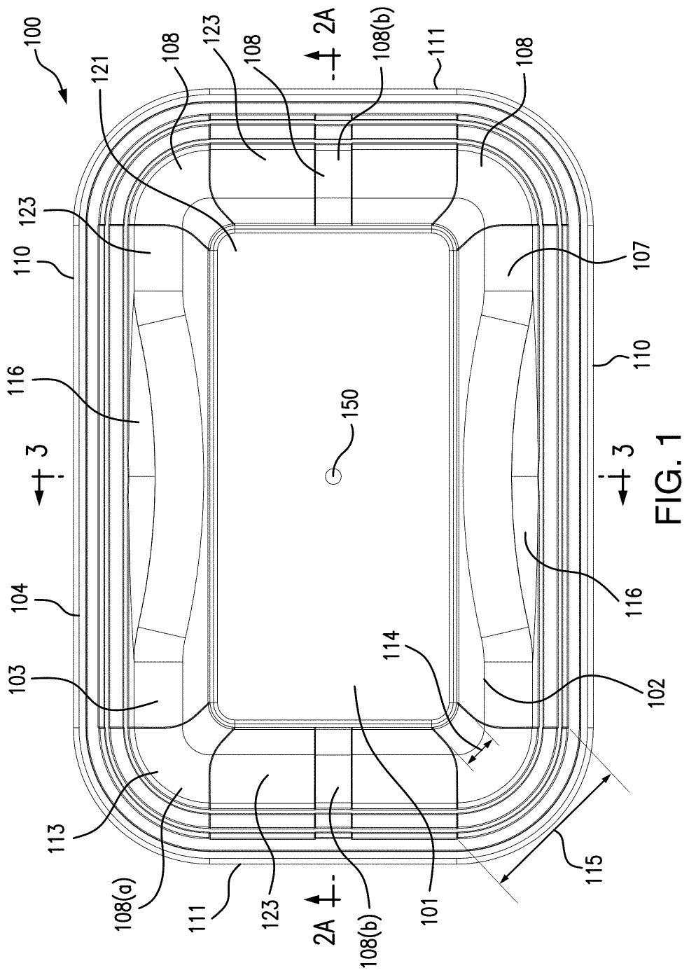

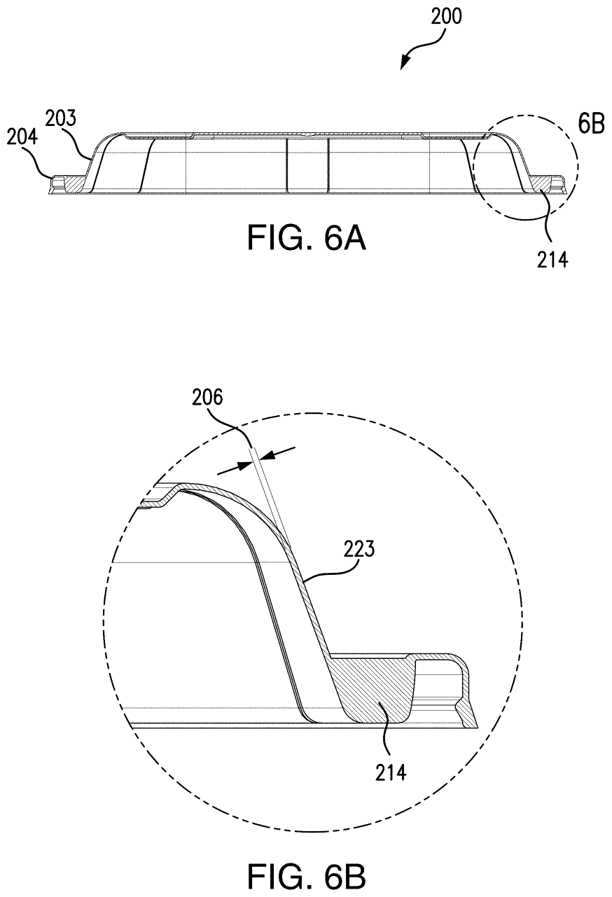

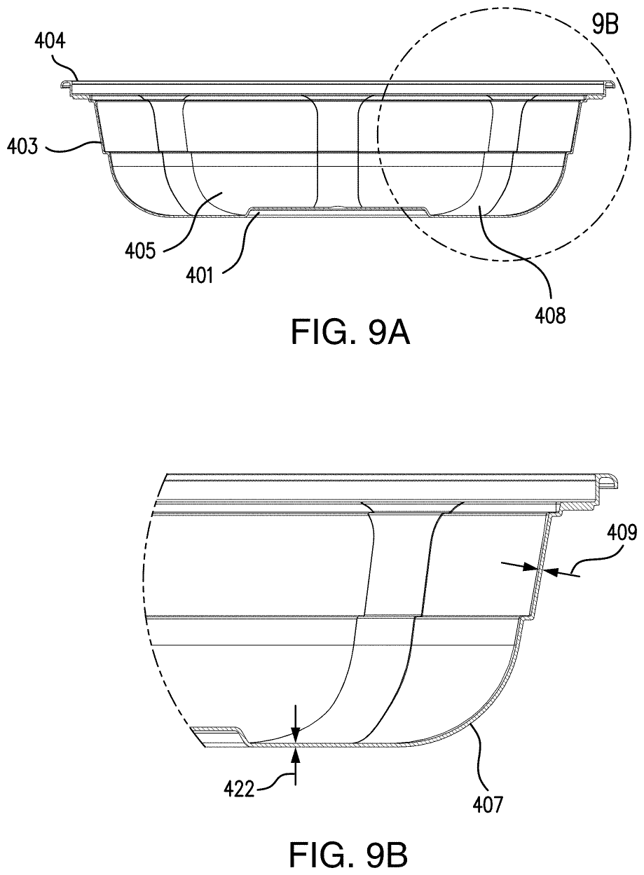

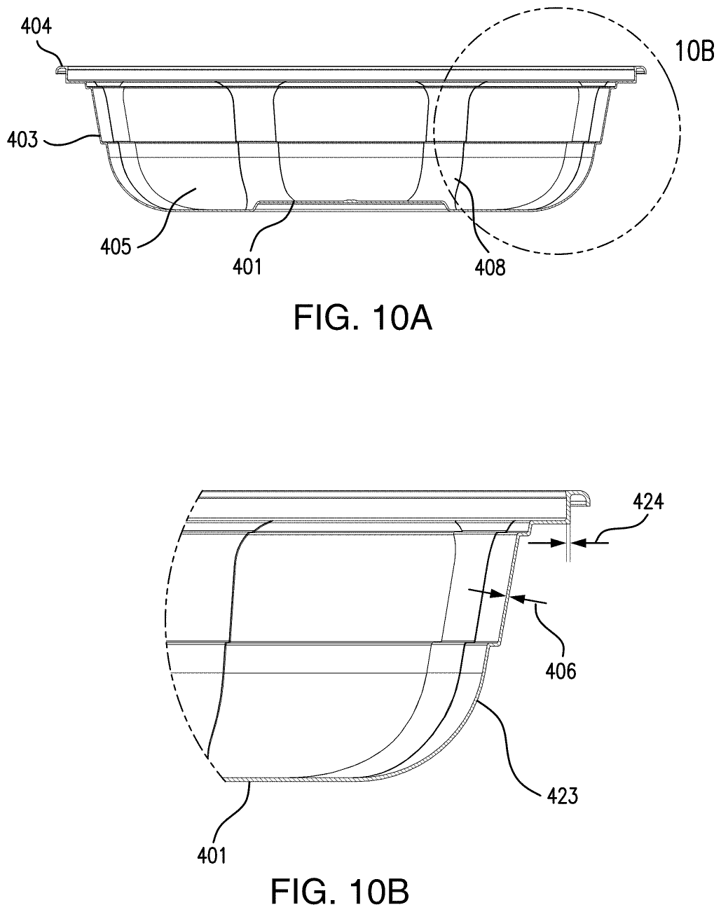

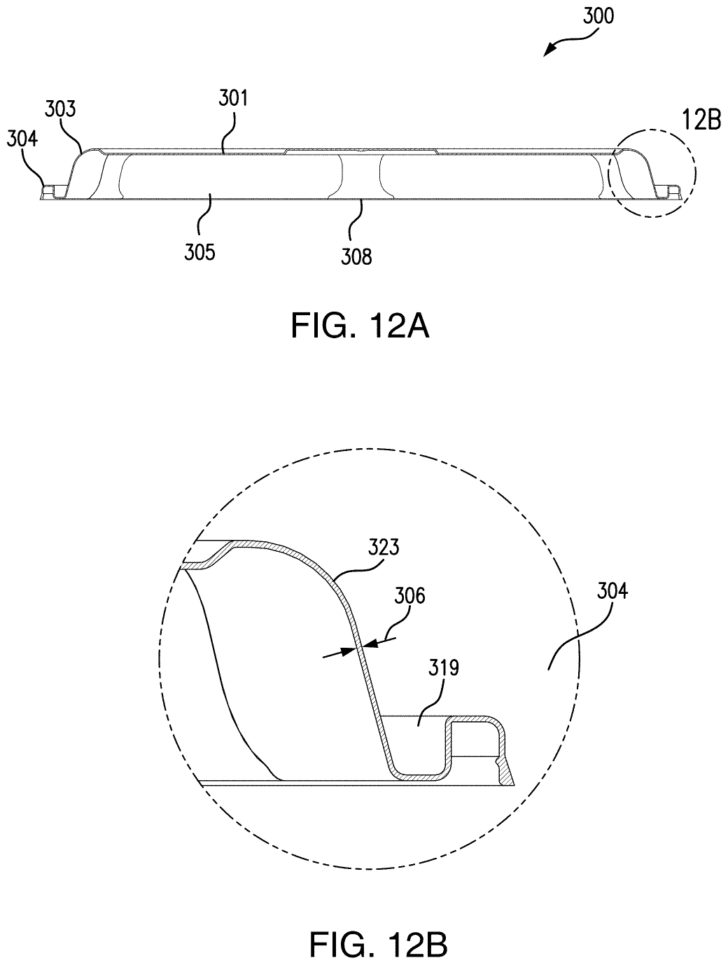

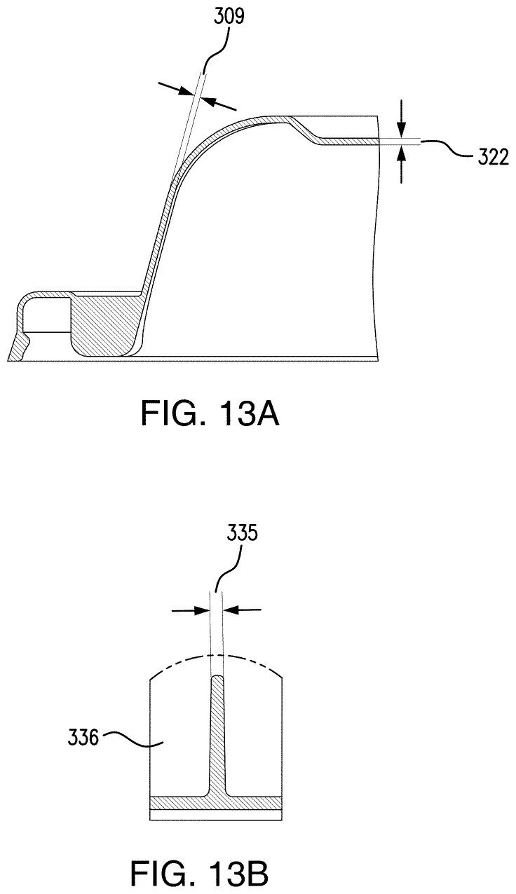

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, exemplary embodiments of the injection molded container article in accordance with the disclosed subject matter are shown in FIGS. 1-14. The injection molded container article of the disclosed subject matter is suitable for use with a wide variety of containers. As used herein, the terms “front,” “rear,” “side,” “top,” and “bottom” are used for the purpose of illustration only, and not limitation. That is, it is recognized that the terms “front,” “rear,” “side,” “top,” and “bottom” are interchangeable and are merely used herein as a point of reference. Additionally, wall thicknesses are described herein and recognized to vary slightly due to manufacture processes, and therefore such descriptions are recognized to represent an average wall thickness with suitable tolerance and variance for the intended purpose.

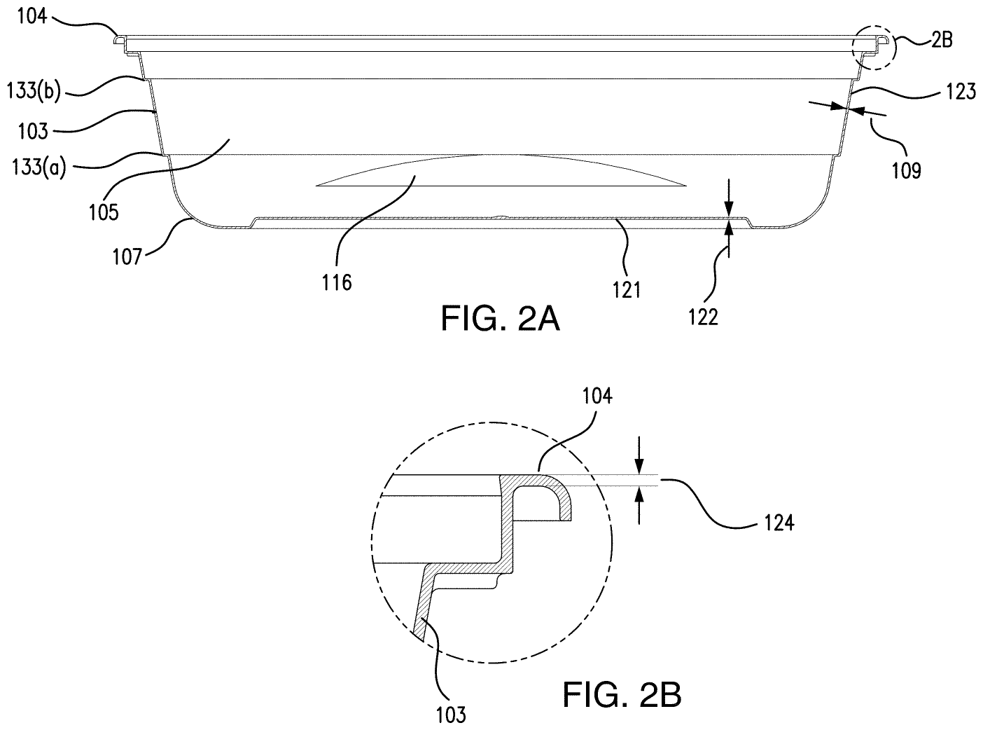

For purpose of illustration, and not limitation, reference is made to the exemplary embodiment of an injection molded container article shown in FIGS. 1-3. As shown in FIGS. 1 and 2A, article 100 generally includes a center portion 101 having an outer perimeter 102. With reference to FIG. 1, the center portion 101 can have any of a variety of suitable shapes in plan view. For example, and without limitation, center portion 101 can have a substantially circular shape or a generally polygonal shape in plan view, such as square or octagonal shape, or as embodied herein, a substantially rectangular shape in plan view.

The center portion 101 has a central flow leader 121 defined therein. The central flow leader 121 can extend across the entire center portion 101. Additionally, or alternatively, and as embodied herein, the central flow leader 121 can be defined in a portion of the center portion within the outer perimeter 102. As described further, an injection site 150 for the injection molding process is disposed within the central flow leader 121. As embodied herein, the central flow leader can be interconnected and in “fluid communication” with a plurality of side wall flow leaders 108 and the outer rim portion 104 to form a portion of a support framework, as further described herein.

The central flow leader 121 has a central flow leader thickness 122 in cross section that is greater than the side wall panel thickness 106. For purpose of example and not limitation, the central flow leader thickness 122 can be between approximately 15 mil and approximately 23 mil. For purpose of example, and as embodied herein, the central flow leader thickness can be substantially equal to the side wall flow leader thickness 109, as described further below. The central flow leader thickness measurements described, along with other thickness measurements described herein, such as side wall panel thickness and side wall flow leader thickness, are described in terms of average thickness across the relevant portion of the injection molded container article.

The article further includes a side wall portion 103 extending from the outer perimeter 102 of the center portion 101 to an outer rim portion 104. The center portion 101 and the side wall portion together define a container space 105 having a volume. As embodied herein, the side wall portion 103 can include a radiused transition portion 107 in side cross section extending from the outer perimeter 102 of the center portion 101. At least a portion of an outer surface of the side wall portion 103 can include a textured matte finish, as further described herein.

The side wall portion 103 includes a plurality of side wall flow leaders 108 and a plurality of side wall panels 123. Each side wall panel 123 extends between adjacent side wall flow leaders 108. As further described herein, the side wall panel thickness 106 can be between approximately 12 mil and approximately 18 mil. The side wall panel thickness 106 is less than the central flow leader thickness 122 and less than the side wall flow leader thickness 109. It is to be understood that the side wall panel thickness of containers in accordance with the disclosed subject matter can vary depending on the desired performance characteristics and size of the injection molded container article. For purpose of example, injection molded container articles configured to have a larger volume container space can have greater side wall panel thickness than articles configured to have a smaller volume container space.

With reference to FIGS. 1 and 2A, the side wall portion 103 includes a plurality of side wall flow leaders 108. The plurality of side wall flow leaders extend between the central flow leader 121 and the outer rim portion 104. As embodied herein, the side wall flow leaders 108 can be interconnected with the central flow leader 121 and the outer rim portion 104. In this manner, the mold used to form the injection molded article of the disclosed subject matter can have regions corresponding to the central flow leader, the plurality of side wall flow leaders and the outer rim, which are in fluid communication with each other to form a framework as described further below. As embodied herein, the plurality of side wall flow leaders can extend into the center portion 101 to connect with the central flow leader 121. Additionally or alternatively, and as further embodied herein, the plurality of side wall flow leaders 108 can be spaced from one another about the side wall portion 103. The number and configuration of the side wall flow leaders can be selected based on the desired performance characteristics and size of the injection molded container article. For purpose of example, and as embodied herein, the article 100 can include six side wall flow leaders spaced about the side wall portion 103.

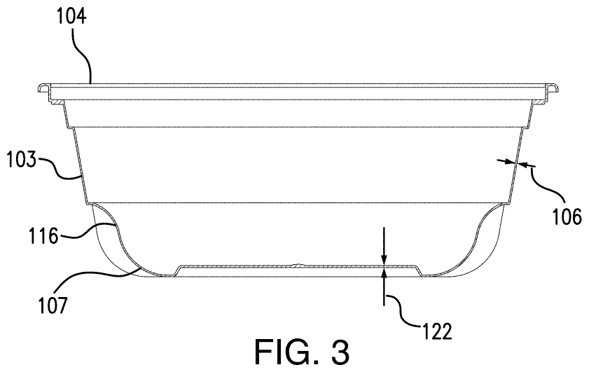

As further described herein, each side wall flow leader 108 has a side wall flow leader thickness 109 in cross section that is greater than the side wall panel thickness 106. For example, and as embodied herein, FIG. 2A depicts a front cross-sectional view of the exemplary injection molded container article of FIG. 1 taken along line 2A-2A as referenced in FIG. 1, with line 2A-2A bisecting side wall flow leaders 108 defined in the side wall portion 103. FIG. 3 depicts a side cross-sectional view of the exemplary injection molded container article of FIG. 1 taken along line 3-3 as referenced in FIG. 1, with line 3-3 bisecting a side wall panel 123. The side wall flow leader thickness 109 depicted in FIG. 2A is greater than the side wall panel thickness 106 depicted in FIG. 3. As further described herein, the side wall flow leader thickness 109 can be between approximately 15 mil and approximately 23 mil. As described above, the side wall flow leader thicknesses are described in terms of average thickness across the portions of the side wall 103 having flow leaders 108 defined therein. As with other thickness dimensions described herein, the flow leader thickness 109 can vary depending on the desired performance characteristics and size of the finished articles. Articles having a larger size can have a larger flow leader thickness 109. For purpose of example, and as embodied herein, the ratio between the side wall panel thickness 106 and the side wall flow leader thickness 109 can be approximately 1:1.25 and approximately 1:1.28. The ratio between side wall panel thickness and side wall flow leader thickness can be used in articles of various sizes and configurations.

The plurality of side wall flow leaders 108 can be defined within the side wall 103 in any suitable configuration. As further described herein, the flow leader configuration can contribute to enhanced performance characteristics of the injection molded container article. For purpose of example, and not limitation, and as embodied herein, the side wall portion 103 can include four radiused corners 113 with opposing side walls therebetween to define a substantially rectangular shape in plan view. The radiused corners 113 can have a radius in plan view between approximately 0.38 inches and approximately 1.45 inches. As further embodied herein, the plurality of side wall flow leaders 108 can include a flow leader 108(a) defined within each radiused corner 113 of the side wall portion 103. Additionally, or alternatively, and as further embodied herein, the plurality of side wall flow leaders 108 can include opposing flow leaders 108(b) defined in a respective pair of the opposing side walls of the side wall portion 103. While a pair of opposing flow leaders 108(b) is depicted in the exemplary embodiment of FIGS. 1-3, it is to be understood that articles in accordance with the disclosed subject matter can include any suitable number of opposing flow leaders 108(b) located at any suitable location along the corresponding pair of opposing side walls. For purpose of example, and as embodied herein, the opposing flow leaders 108(b) can be located at respective midpoints along the pair of opposing side walls. Opposing flow leaders 108(b) can be defined in each pair of opposing side walls. Additionally or alternatively, and as embodied herein, the opposing flow leaders 108(b) can be defined in one pair of opposing side walls. With reference to the exemplary embodiment of FIGS. 1-3, the side wall portion 103 can include opposing long side walls 110 and opposing short side walls 111, and the opposing flow leaders 108(b) can be located at midpoints of the opposing short side walls 111.

The plurality of side wall flow leaders 108 can have a variety of suitable shapes in accordance with the disclosed subject matter. For purpose of example, and not limitation, and with reference to opposing flow leaders 108(b) in the exemplary article of FIG. 1, the plurality of side wall flow leaders 108 can include flow leaders with a generally rectangular shape as generally seen in plan view. Additionally, or alternatively, the plurality of side wall flow leaders 108 can include flow leaders having any other suitable shape in plan view, such as a generally trapezoidal shape, a generally triangular shape, an hourglass shape, and as further embodied herein, a funnel-like shape. For purpose of example and not limitation, and with reference to flow leader 108(a) in FIG. 1, a flow leader can have a first width 114 proximate the central flow leader 121 and a second width 115 proximate the outer rim portion 104. As embodied herein, the first width can be less than the second width.

In accordance with the disclosed subject matter, the plurality of side wall flow leaders 108 extend between the central flow leader 121 and the outer rim portion 104. The central flow leader thickness 122 and the side wall flow leader thickness 109 are each greater than the side wall panel thickness 106. As embodied herein, the outer rim portion 104 can have an outer rim thickness 124 greater than the side wall panel thickness 106. Collectively, the central flow leader 121, the plurality of side wall flow leaders 108, and the outer rim portion 104 can be interconnected to define a support framework for increased top load crush resistance, as described further herein. Additionally, for purpose of injection molding, the central flow leader 121, the plurality of side wall flow leaders 108, and the outer rim portion 104 are interconnected in fluid communication to enhance flow of molten material during the injection molding process, as described further herein.

Injection molded container articles in accordance with the disclosed subject matter can have a variety of uses. For purpose of example, and as embodied herein with reference to FIGS. 1-3, the injection molded container article 100 can form the base of a container. The center portion 101 can define a horizontal support surface of the container base and the side wall portion 103 can extend upwardly from the perimeter 102 of the center portion 103 to the outer rim portion 104. For purpose of example, and as embodied herein, the side wall portion can include one or more stepped portions 133(a) and 133(b) as the side wall portion extends between the perimeter 102 of the center portion 101 to the outer rim portion 104.

As further embodied herein, the side wall portion can include a radiused transition portion 107 in side cross-section extending upwardly from the outer perimeter 102 of the center portion 101. For purpose of example and not limitation, the radiused transition portion 107 can have a radius of between approximately 0.44 inches and approximately 0.66 inches. Additionally, and as further embodied herein, at least a portion of the side wall portion 103 can extend upwardly from the radiused transition portion 107 to define a convex surface 116 in side cross-section relative to the container space. In this manner, and with reference to FIG. 3, the radiused transition 107 and the convex surface 116 can define a sinusoid when viewed in cross-section. Various areas of the side wall portion 113 can include a convex surface 116 depending on the desired design and/or performance characteristics of the article. For purpose of example, and as embodied herein, the side wall portion 113 can include opposing long side walls 110 and opposing short side walls 111 to define a substantially rectangular shape, and convex surfaces 116 can be located on the opposing long side walls 110. Such a configuration can provide improved ergonomics and strength.

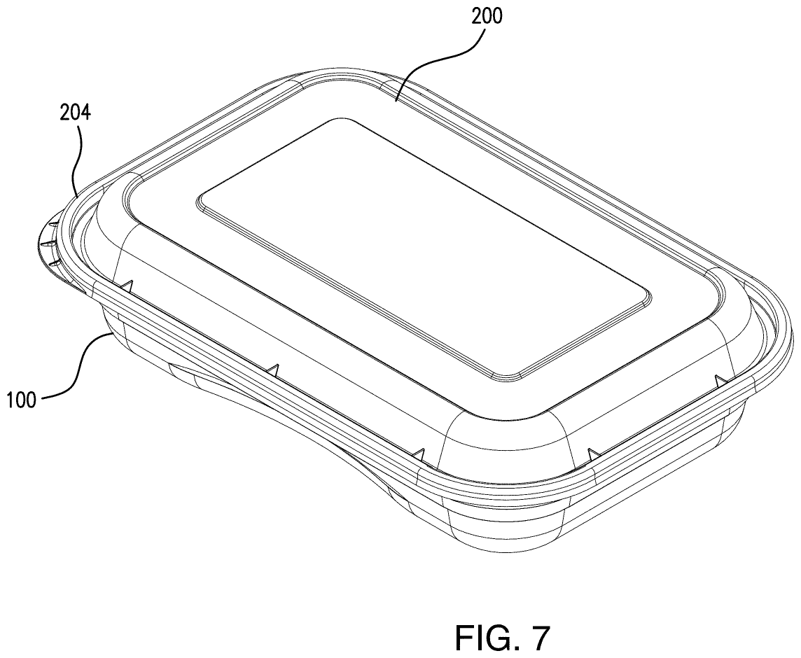

With reference to FIG. 7, the injection molded container article 100 can further include a lid 200 having a lid rim portion 204. The lid 200 can be any suitable lid. Additionally, or alternatively, and as further described herein, the lid 200 can be an injection molded container article in accordance with the disclosed subject matter. For purpose of example, and as embodied herein, the lid can include a lid side wall portion 203 having a plurality of side wall flow leaders 208 and a plurality of side wall panels 223 extending between adjacent side wall flow leaders 208. The outer rim portion 104 can be engageable with the lid rim portion 204 in a closed position. Various configurations and methods for engagement of an outer rim portion and inner rim portion are known in the art, including those described in U.S. Pat. Nos. 10,220,986, 6,056,138, and 6,196,404, the contents of which are hereby incorporated by reference in their entirety.

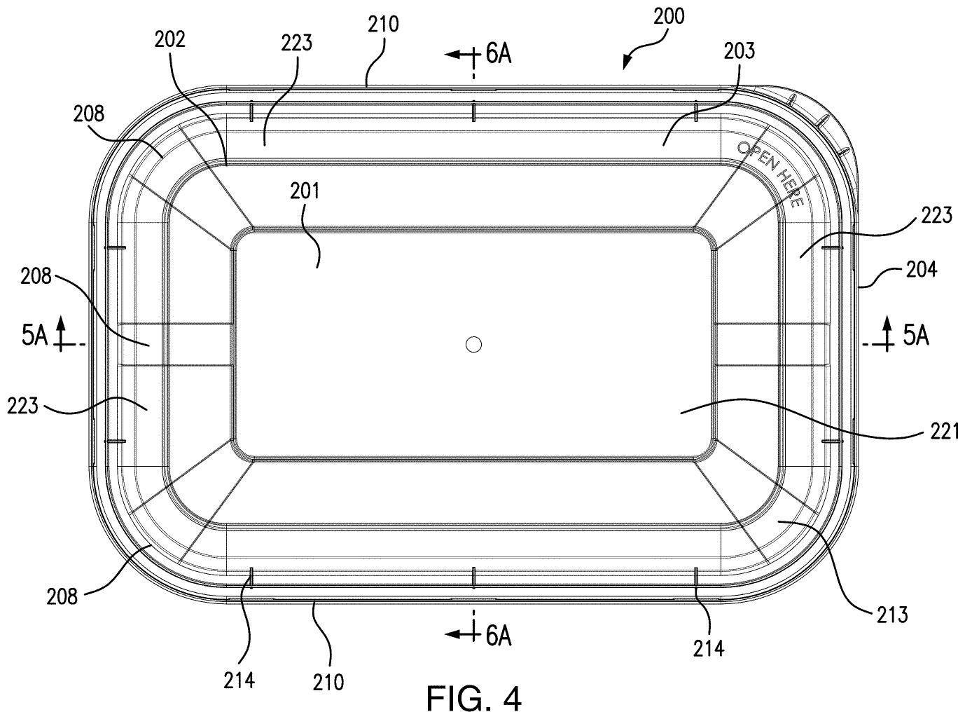

With reference to another exemplary embodiment of an injection molded container article in accordance with the disclosed subject matter, the injection molded container article can form the lid of a container, such as depicted in FIGS. 4-6B. Such a lid can be used with a conventional base, or with a base in accordance with the disclosed subject matter. The injection molded container article 200 includes a center portion 201 having an outer perimeter 202. The center portion 201 has a central flow leader 221 defined therein, the central flow leader 221 having a central flow leader thickness. The article 200 further includes a side wall portion 203 extending from the outer perimeter 202 of the center portion 201 to an outer rim portion 204. The side wall portion 203 includes a plurality of side wall flow leaders 208 and a plurality of side wall panels 223 extending between adjacent side wall flow leaders 108. As further described herein, the side wall panels 224 each have a side wall panel thickness 206 that is less than the central flow leader thickness. As embodied herein, the center portion 201 can define an upper surface of a lid with the side wall portion 203 extending downwardly from the perimeter of the center portion 201 to the outer rim portion 204. The center portion 201 and the side wall portion 203 together define a container space 205 having a volume.

The side wall portion 203 includes a plurality of side wall flow leaders 208 defined therein, with each side wall flow leader 208 having a side wall flow leader thickness 209 that is greater than the side wall panel thickness 206. Each flow leader 208 extends from the central flow leader 221 to the outer rim portion 204. As further described herein, the central flow leader 221, the plurality of side wall flow leaders 208, and the outer rim portion 204 can be interconnected to define a support framework. For purpose of example, and as embodied herein, the injection molded container article and lid 200 can have some or all substantially similar features to those previously described with respect to the injection molded container article 100 (e.g., number and spacing of side wall flow leaders, and configuration of flow leader width).

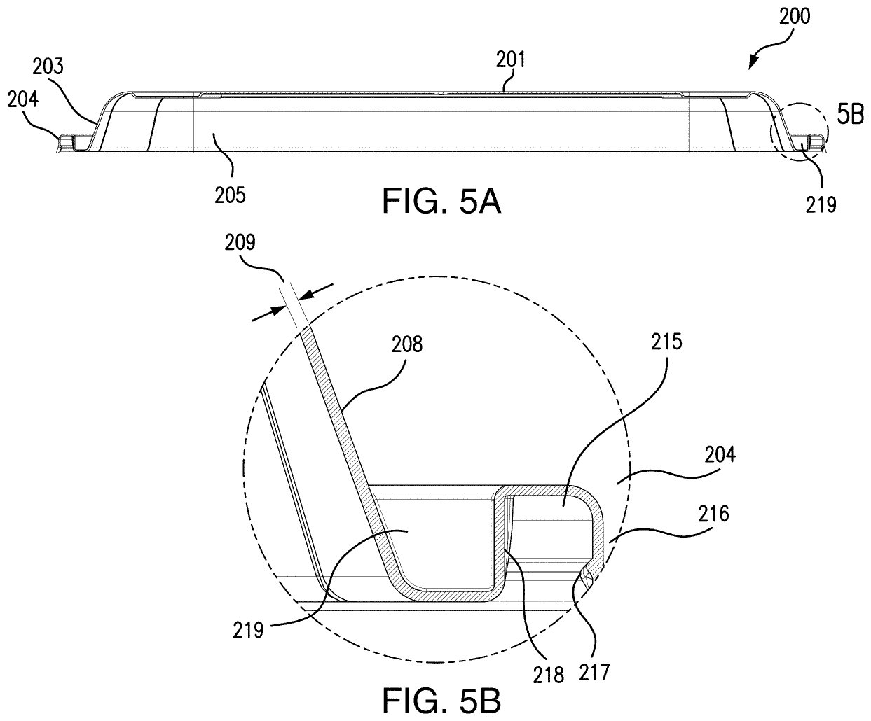

Additionally, and as embodied herein, the outer rim portion 204 of the article 200 can include a fastener. The fastener can be used, for example, to fasten the article 200 to a corresponding container base. The fastener can have any suitable configuration. With reference to FIG. 5B, the fastener can include a lid interlocking lip portion 216 opposite a vertical lip sidewall area 218 with a lip space 215 defined therebetween. As embodied herein, the interlocking lip portion 216 can include a lock portion 217. The lip space 215 can be configured to receive a corresponding portion of a container base. For purpose of example, and as embodied herein, the lip space 215 can be configured to receive the outer rim portion 104 of article 100.

As further embodied herein, the article 200 can include a channel 219 between the side wall portion 203 and the outer rim portion 204. The channel can be of any suitable shape and dimension. For purpose of example, and as embodied herein, the channel can have a channel depth in cross section of between approximately 130 mil and approximately 210 mil. Articles in accordance with the disclosed subject matter can further include a plurality of ribs 214, such as a fin of suitable thickness, extending across the channel 219 between the side wall portion 203 and the outer rim portion 204. The ribs 214 can include any suitable even number of ribs arranged at any suitable location along the outer rim depending on the desired performance characteristics of the article, such as increased strength or rigidity. For purpose of example, and as embodied herein, the article 200 can include ribs 214 disposed proximate either side of each radiused corner 213 and further include ribs 214 disposed proximate a midpoint of opposing long sides 210.

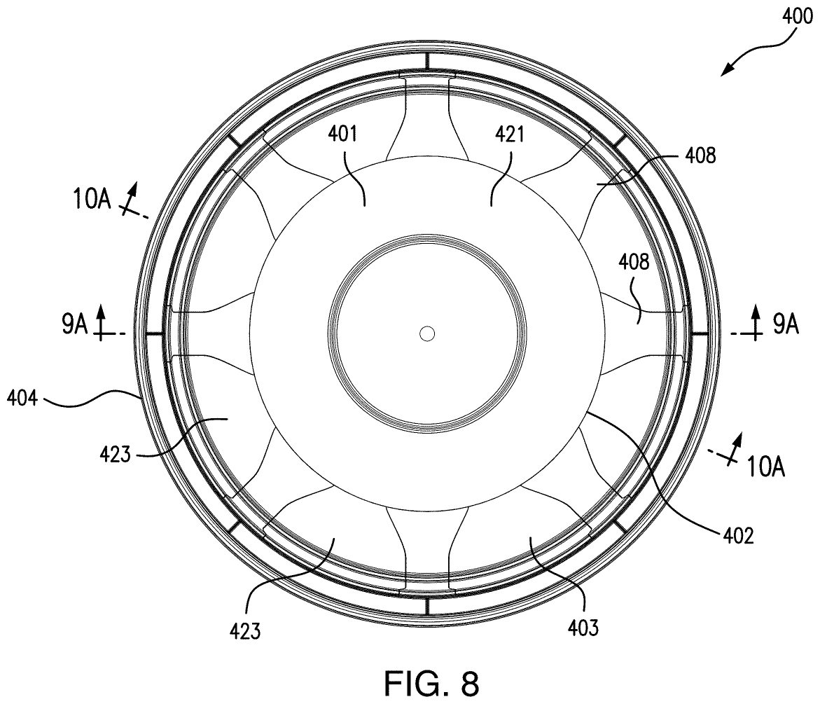

With reference to the exemplary embodiments of FIGS. 8-10B and FIGS. 11-13B, the side wall portion can have a substantially circular shape in plan view. With reference to the exemplary embodiment of an injection molded container article in accordance with the disclosed subject matter depicted in FIGS. 8-10B, the injection molded container article 400 can form a container base. The injection molded container article 400 includes a center portion 401 having an outer perimeter 402. The center portion 401 has a central flow leader 421 defined therein, the central flow leader 421 having a central flow leader thickness 422. As previously described, the injection site for the injection molded article is disposed within the central flow leader 421. The article 400 further includes a side wall portion 403 extending from the outer perimeter 402 of the center portion 401 to an outer rim portion 404. As further described herein, the side wall portion 403 includes a plurality of side wall panels 423, each side wall panel 423 extending between adjacent flow leaders 408 and having a side wall panel thickness 406 that is less than the central flow leader thickness. As embodied herein, the center portion 401 can define a horizontal support surface of a container base, and the side wall portion 403 can extend upwardly from the perimeter 402 of the center portion 401 to the outer rim portion 404. The center portion 401 and the side wall portion 403 together define a container space 405 having a volume. As embodied herein, the side wall portion 403 can include a radiused transition portion 407 in side cross section extending from the outer perimeter 402 of the center portion 401. For purpose of example, and as embodied herein, the radiused transition portion 407 of the exemplary circular base 400 can have a larger radius than the radiused transition portion 107 of the exemplary rectangular base 100.

The side wall portion 403 includes a plurality of side wall flow leaders 408 defined therein, with each side wall flow leader 408 having a side wall flow leader thickness 409 that is greater than the side wall panel thickness 406. The plurality of side wall flow leaders 408 extend between the central flow leader 421 and the outer rim portion 404. The central flow leader thickness 422 and the side wall flow leader thickness 409 are each greater than the side wall panel thickness 406. As embodied herein, the outer rim portion 404 can have an outer rim thickness 424 greater than the side wall panel thickness 406. Collectively, the central flow leader 421, the plurality of side wall flow leaders 408, and the outer rim portion 404 can be interconnected to define a support framework for increased top load crush resistance, as described further herein. Additionally, for purpose of injection molding, the central flow leader 421, the plurality of side wall flow leaders 408, and the outer rim portion 404 can be interconnected in fluid communication to enhance flow of molten material during the injection molding process, as described further herein. As embodied herein, the injection molded container article 400 can have some or all substantially similar features to those described with respect to the exemplary injection molded container articles previously described (e.g., number and spacing of side wall flow leaders, and configuration of flow leader width). For purpose of example, and as embodied herein, the article 400 can include eight side wall flow leaders. The side wall flow leaders 408 can be evenly spaced about the side wall 403, as further described herein.

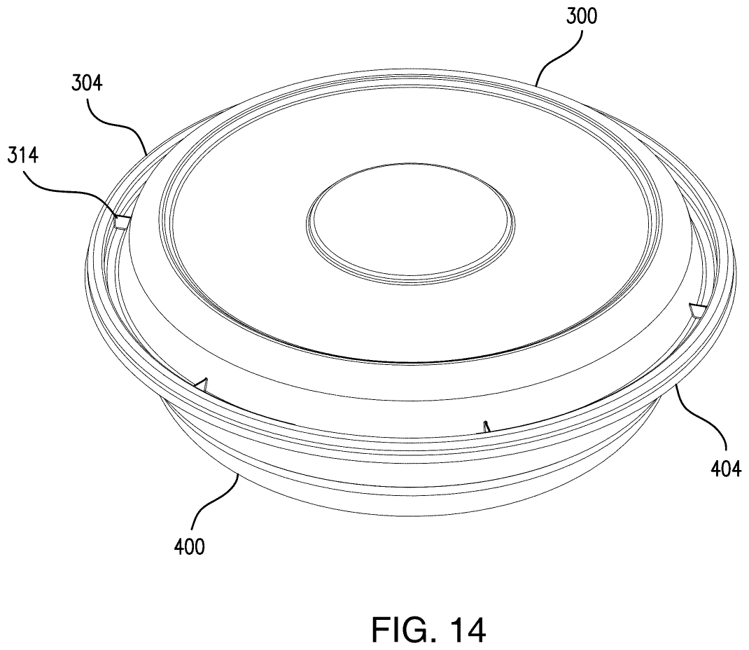

As described above, the injection molded container article 400 can further include a lid having a lid rim portion, and the outer rim portion 404 of article 400 can be engageable with the lid rim portion in a closed position. The lid can be any suitable lid with any suitable lid rim portion for engagement with the outer rim portion 404. For purpose of example, and as embodied herein, the lid can be an injection molded container article in accordance with the disclosed subject matter. With reference to FIG. 14, the outer rim portion 304 of article 300 can engage with the outer rim portion 404 of article 400 in a closed position.

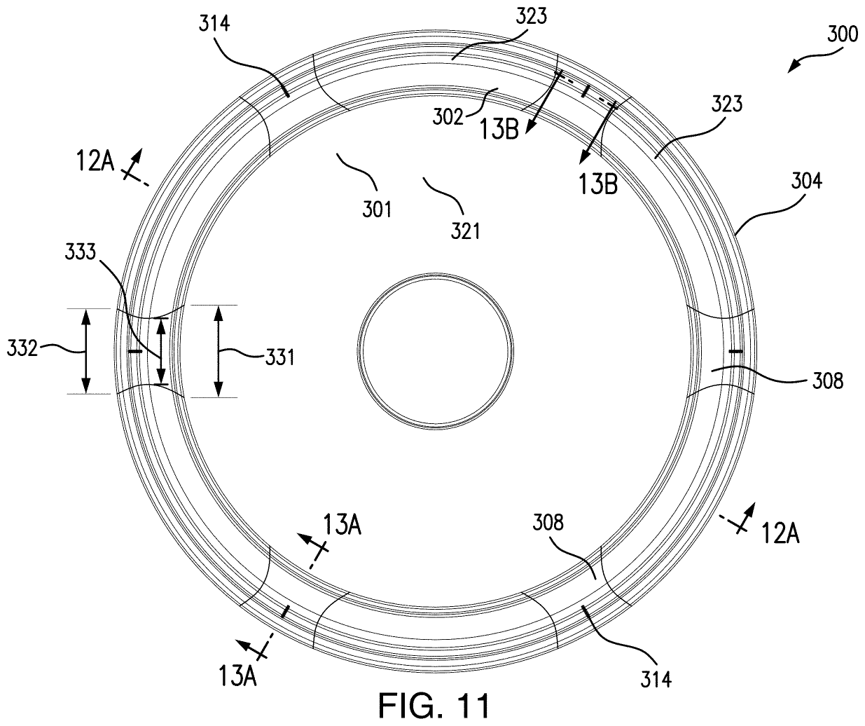

With reference to the exemplary embodiment of an injection molded container article in accordance with the disclosed subject matter depicted in FIGS. 11-13B, the injection molded container article 300 can form the lid of a container. The injection molded container article 300 includes a center portion 301 having an outer perimeter 302. As previously described, the injection site for the injection molded article is disposed within the central flow leader 321. The center portion 301 has a central flow leader 321 defined therein, the central flow leader 321 having a central flow leader thickness 322. The article 300 further includes a side wall portion 303 extending from the outer perimeter 302 of the center portion 301 to an outer rim portion 304. As further described herein, the side wall portion 303 includes a plurality of side wall panels 323, each side wall panel 423 extending between adjacent side wall flow leaders 108 and having a side wall panel thickness 306 that is less than the central flow leader thickness 322. As embodied herein, the center portion 301 can define an upper surface of a lid with the side wall portion 303 extending downwardly from the perimeter of the center portion 301 to the outer rim portion 304. The center portion 301 and the side wall portion 303 together define a container space 305 having a volume.

As shown in FIGS. 11-13A, the side wall portion 303 includes a plurality of side wall flow leaders 308 defined therein, with each side wall flow leader 308 having a side wall flow leader thickness 309 that is greater than the side wall panel thickness 306. Each side wall flow leader 308 extends from the central flow leader 321 to the outer rim portion 304. As further described herein, the central flow leader 321, the plurality of side wall flow leaders 308, and the outer rim portion 304 can be interconnected to define a support framework. For purpose of example, and as embodied herein, the injection molded container article 300 can have some or all substantially similar features to those previously described with respect to the exemplary injection molded container article 100, exemplary injection molded container article 200, and exemplary container article 400.

For example, and as described above, the plurality of side wall flow leaders 308 can be defined within the side wall 303 in any suitable configuration. For purpose of example, and as embodied herein, the plurality of side wall flow leaders 308 can be equally spaced from one another about the outer side wall portion 303. Additionally or alternatively, and as further embodied herein, at least one of the plurality of side wall flow leaders 308 can have a first width 303 proximate the central flow leader 321, and a second width 332 proximate the outer rim portion 304 with an intermediate flow leader width 333 therebetween. The intermediate flow leader width 333 can be less than the first and second flow leader widths as shown in FIG. 11. For purpose of example, and as embodied herein, at least one of the side wall flow leaders 308 can define an hourglass shape in plan view. As further described herein, the shape and configuration of the side wall flow leaders 308 can be selected based on the desired performance characteristics of the article. For example, the use of hourglass shaped side wall flow leaders can reduce the tendency of circular articles to warp during the cooling process after injection molding.

As described above, the article 300 can further include a channel 319 between the side wall portion 303 and the outer rim portion 304 with a plurality of ribs 314 extending across the channel 319. For purpose of example and not limitation, and with reference to FIG. 13B, the ribs 314 can have a thickness 335 in cross section of between approximately 12 mill and approximately 19 mil. The plurality of ribs 314 can have a height 336 of between approximately 130 mil and approximately 210 mil. For purpose of example, and as embodied herein, the height can be selected such that the plurality of ribs have a height 336 substantially equal to the depth of the channel. As described above, any suitable number of ribs 314 can be arranged at suitable locations along the outer rim 304 depending on the desired performance characteristics of the article, such as increased strength or rigidity. For purpose of example, and as embodied herein, the plurality of ribs 314 can be aligned with the plurality of side wall flow leaders 308.

In accordance with another aspect of the disclosed subject matter, a method of making an injection molded container article is provided. The method generally includes providing a mold configured to form a container article. The mold includes a center portion having an outer perimeter, the center portion having a central flow leader defined therein. The central flow leader has a central flow leader thickness. The mold further includes a side wall portion extending from the outer perimeter of the center portion to an outer rim portion. The center portion and the side wall portion together define a container space having a volume. The side wall portion includes a plurality of side wall flow leaders and a plurality of side wall panels, each side wall panel extending between adjacent side wall flow leaders. Each side wall panel has a side wall panel thickness less than the central flow leader thickness. Additionally, each side wall flow leader has a side wall flow leader thickness greater than the side wall panel thickness. Each side wall flow leader extends between, and is in fluid communication with, the central flow leader and the outer rim portion.

The method further includes injecting molten material into the mold proximate the central flow leader. The molten material is first directed from the central flow leader along the plurality of side wall flow leaders to fill the outer rim portion, and the molten material backfills the side wall panels between the plurality of side wall flow leaders.

For purpose of example, and with reference to the exemplary embodiment of an injection molded container article 100 depicted in FIG. 1, molten material can be injected into the mold proximate the injection site or gate region 150 within the central flow leader 121. As previously noted, the mold for the article is configured with the central flow leader 121 in fluid communication with the plurality of side wall flow leaders 108 and the outer rim portion 104. After the molten material enters the region of the mold defining central flow leader 121, the molten material is directed from the central flow leader 121 along the regions of the mold defining the plurality of side wall flow leaders 108 to fill the outer rim portion 104. The central flow leader thickness 122, the side wall flow leader thickness 109, and outer rim thickness 144 are each greater than the side wall panel thickness 106. Hence, the molten plastic generally will sequentially fill these regions first (i.e. central flow leader 121, then the plurality of side wall flow leaders 108, then outer rim portion 104). After filing the outer rim portion 104, the molten material will then backfill the side wall panels 123 between adjacent side wall flow leaders 108.

The injection molded container articles of the disclosed subject matter can be made from any suitable polymeric materials, including but not limited to low-density polyethylene, polyethylene terephthalate, polyethylene naphthalate (“PEN”), PEN blends, polyvinyl chloride, polypropylene, fluorine treated high density polyethylene, post-consumer resin, K-resin, bioplastic, or a mixture, blend, or copolymer thereof. Conventional injection molding parameters and techniques can be employed.

The injection molded container articles of the disclosed subject matter have demonstrated desired performance characteristics not achieved by conventional injection molded articles or the like without flow leaders. The fluid communication between the central flow leader, the plurality of side wall flow leaders, and the outer rim portion can allow molten material to reach the outer rim portion more easily during the injection molding process than it would otherwise be able to in a comparative article of substantially similar size, shape and construction but without any flow leaders. The configuration of the flow leaders can allow for the use of side wall panels with decreased thickness, as the configuration of flow leaders can allow molten material to reach the outer rim portion and prevent the formation of voids during the injection molding process.

Additionally, the central flow leader, the plurality of side wall flow leaders, and the outer rim portion can be interconnected in the finished injection molded container articles of the disclosed subject matter to define a support framework having an increased strength in comparison with a side wall without flow leaders. Articles in accordance with the disclosed subject matter incorporating such a support framework can have enhanced performance characteristics, such as greater top load crush resistance strength to weight ratio, as compared to comparative articles of substantially similar size, shape and construction but without any flow leaders.

For purpose of example, articles in accordance with the disclosed subject matter can provide top load crush resistance strength to weight ratios equal to or greater than top load crush resistance strength to weight ratios of comparative injection molded articles having substantially similar size, shape and construction as the injection molded container articles in accordance with the disclosed subject matter but without any flow leaders. Particularly, articles in accordance with the disclosed subject matter can maintain such performance while having reduced overall side wall thickness and overall article weight as compared to comparative articles of substantially similar size, shape and construction but without any flow leaders. For example, and as embodied herein, articles in accordance with the disclosed subject matter can provide top load crush resistance strength to weight ratios equal to or greater than a top load crush resistance strength to weight ratio of a comparative injection molded article, and the articles in accordance with the disclosed subject matter can have a side wall panel thickness between approximately 5 percent to approximately 30 percent less than a side wall thickness of the comparative injection molded article having an otherwise substantially similar size, shape and construction as the injection molded container article but without any flow leaders. As further embodied herein, articles in accordance with the disclosed subject matter can provide top load crush resistance strength to weight ratios equal to or greater than a top load crush resistance strength to weight ratio of a comparative injection molded article, and the articles in accordance with the disclosed subject matter can have a side wall panel thickness between approximately 25 percent to approximately 50 percent less than a side wall thickness of the comparative injection molded article having an otherwise substantially similar size, shape and construction as the injection molded container article but without any flow leaders.

Additionally or alternatively, articles in accordance with the disclosed subject matter can provide top load crush resistance strength to weight ratios equal to or greater than a top load crush resistance strength to weight ratio of a comparative injection molded article, and the articles in accordance with the disclosed subject matter can weigh approximately 10 percent to approximately 30 percent less than the comparative injection molded article having an otherwise substantially similar size, shape and construction as the injection molded container article but without any flow leaders. For purpose of example and not limitation, and as further described herein, articles in accordance with the disclosed subject matter can have a top load crush resistance between approximately 125 lbf and approximately 250 lbf.

For purpose of comparison, container articles having substantially similar size can have substantially similar interior volumes. For example, containers having substantially similar size can have interior volumes within approximately 5% to approximately 20% of one another. More preferably, containers having substantially similar size can have interior volumes within approximately 5% to approximately 10% of one another. Containers having substantially similar shape can, for example, each have a substantially circular shape in plan view or each have a substantially rectangular shape in plan view. Additionally, containers having substantially similar construction can each be made from, for example, polyethylene terephthalate or each be made from, for example, polyethylene naphthalate.

### EXAMPLES

For purpose of understanding and not limitation, data is provided to demonstrate various properties of and operational characteristics achieved by the injection molded container articles disclosed herein. For purpose of illustration and comparison, testing was performed to compare the characteristics of exemplary container articles in accordance with the disclosed subject matter to the characteristics of comparative injection molded articles having substantially similar sizes, shapes, and constructions as the container articles in accordance with the disclosed subject matter but without any flow leaders.

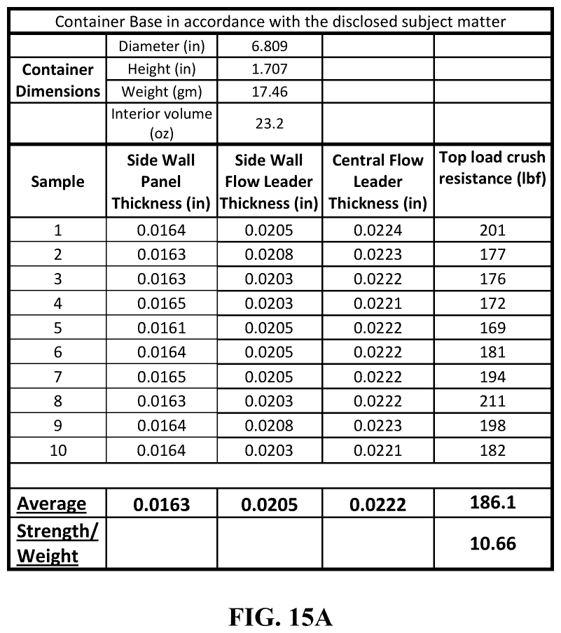

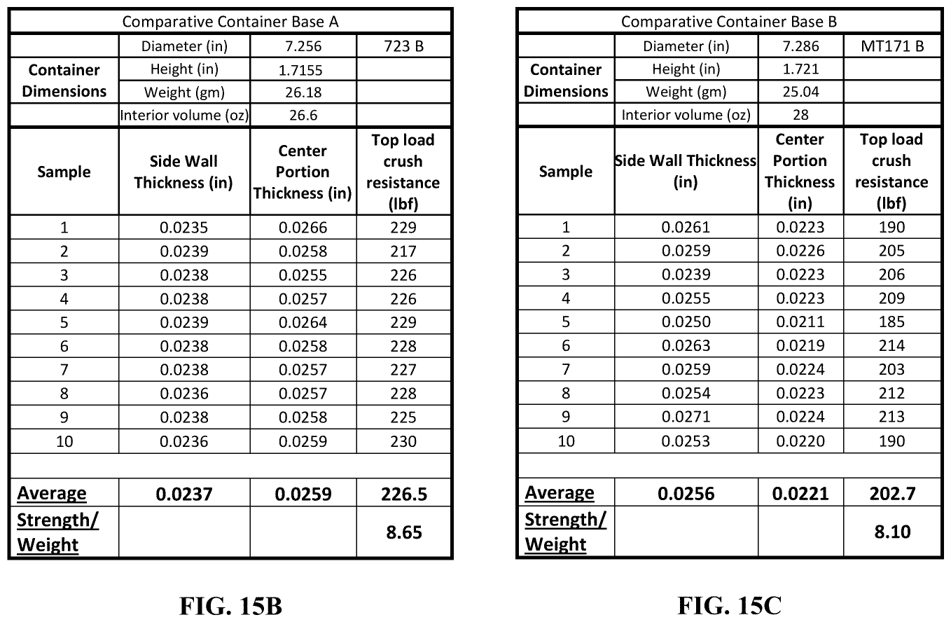

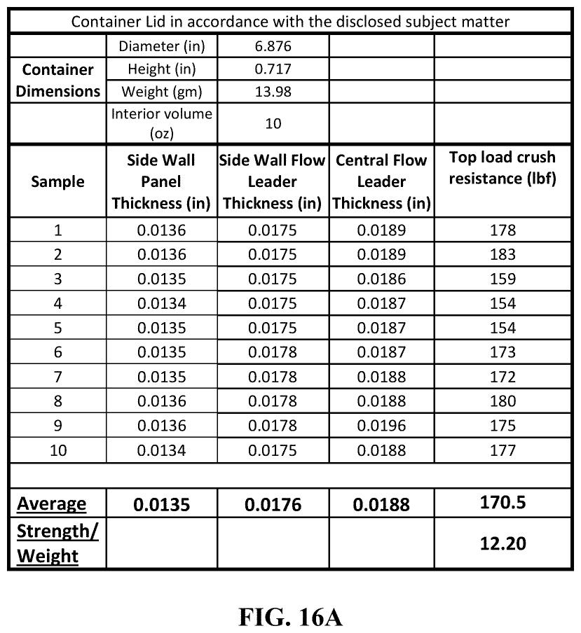

As described further with respect to FIG. 15A-FIG. 20B, top load crush resistance was measured to compare the characteristics of exemplary container articles in accordance with the disclosed subject matter to the characteristics of comparative injection molded articles having substantially similar sizes, shapes, and constructions as the container articles in accordance with the disclosed subject matter but without any flow leaders. An even planar load was applied to the container articles during testing. Top load crush resistance measurements were obtained using a digital force measurement gauge as commercially available from Imada, Inc, and data acquisition software as commercially available from WinWedge under product codes SW-1X-V3 and DB-1X.

Each of the articles in accordance with the disclosed subject matter and the comparative injection molded articles having substantially similar size, shape, and construction, but without flow leaders measured and compared herein were made of polypropylene.

### Example 1

With reference to FIG. 15A-FIG. 15C, articles in accordance with the disclosed subject matter configured to form a base of a container were measured and compared to comparative injection molded articles having substantially similar size, shape, and construction, but without flow leaders, configured to form a base of a container. The exemplary container articles in accordance with the disclosed subject matter configured to form a container base, and the comparative injection molded articles having substantially similar size, shape, and construction but without flow leaders and configured to form a base, each had a substantially circular shape in plan view and each had an interior volume of between approximately 23.2 ounces and approximately 28 ounces.

For purpose of comparison, the side wall panel thickness, side wall flow leader thickness, central flow leader thickness, and top load crush resistance was measured in ten exemplary container articles in accordance with the disclosed subject matter having a substantially circular shape and configured to form a container base. With reference to FIG. 15A, the exemplary container articles in accordance with the disclosed subject matter tested had an average diameter of approximately 6.809 inches, an average height of approximately 1.707 inches, and an average interior volume of approximately 23.2 ounces. The exemplary container articles in accordance with the disclosed subject matter tested had an average side wall panel thickness of approximately 19.4 mil, an average side wall flow leader thickness of approximately 22.0 mil, and an average central flow leader thickness of approximately 22.2 mil. The exemplary container articles in accordance with the disclosed subject matter tested had an average top load crush resistance of approximately 186.1 lbf and an average weight of approximately 17.46 grams. Accordingly, the exemplary container articles in accordance with the disclosed subject matter had an average top load crush resistance strength to weight ratio of approximately 10.66.

For purpose of comparison, the side wall thickness, center portion thickness, and top load crush resistance was measured in two types of comparative container articles having substantially similar size, shape, and construction but without flow leaders and configured to form a container base: ten comparative articles of type A and ten comparative articles of type B, respectively. With reference to FIG. 15B, the type A comparative articles of substantially similar size, shape, and construction but without flow leaders were of substantially circular shape in plan view and had an average diameter of approximately 7.256 inches, an average height of approximately 1.7155 inches, and an average interior volume of approximately 26.6 ounces. The type A comparative articles had an average side wall thickness of approximately 23.7 mil, an average center portion thickness of approximately 25.9 mil, and an average top load crush resistance of approximately 226.5 lbf. The type A comparative articles had an average weight of approximately 26.18 grams. Accordingly, the type A comparative articles of substantially similar size, shape, and construction but without flow leaders had an average top load crush resistance strength to weight ratio of approximately 8.65.

With reference to FIG. 15C, the type B comparative articles of substantially similar size, shape, and construction but without flow leaders were of substantially circular shape in plan view and had an average diameter of approximately 7.286 inches, an average height of approximately 1.721 inches, and an average interior volume of approximately 25.04 ounces. The type B comparative articles tested are commercially available from Tripak with a product code of MT1710B. The type B comparative articles had an average side wall thickness of approximately 25.6 mil, an average center portion thickness of approximately 22.1 mil, and an average top load crush resistance of approximately 202.7 lbf. The type B comparative articles had an average weight of approximately 28 grams. Accordingly, the type B comparative articles of substantially similar size, shape, and construction but without flow leaders had an average top load crush resistance strength to weight ratio of approximately 8.10.

For purpose of comparison, the exemplary container articles in accordance with the disclosed subject matter tested as summarized in FIG. 15A had a top load crush resistance strength to weight ratio of approximately 23% greater than the top load crush resistance strength to weight ratio of the type A comparative articles. The exemplary container articles in accordance with the disclosed subject matter tested as summarized in FIG. 15A had a top load crush resistance strength to weight ratio of approximately 31.6% greater than the top load crush resistance strength to weight ratio of the type B comparative articles. The exemplary container articles in accordance with the disclosed subject matter had a side wall panel thickness of approximately 31% less than the side wall thickness of the type A comparative articles and approximately 36% less than the side wall thickness of the type B comparative articles. Additionally, the exemplary container articles in accordance with the disclosed subject matter weighed approximately 33% less than the type A comparative articles and approximately 30% less than the type B comparative articles.

### Example 2

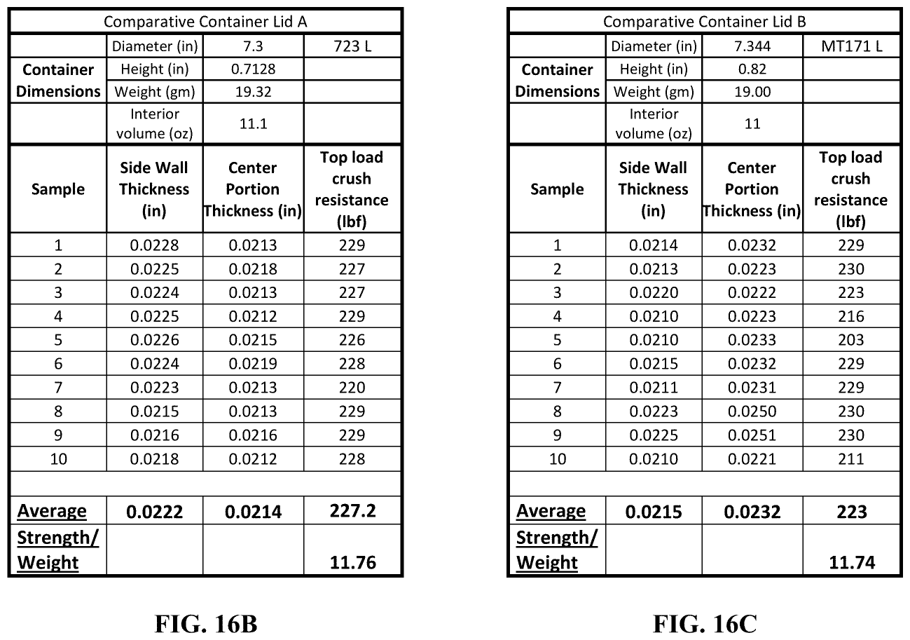

With reference to FIG. 16A-FIG. 16C, articles in accordance with the disclosed subject matter configured to form a lid of a container were measured and compared to comparative injection molded articles having substantially similar size, shape, and construction, but without flow leaders, configured to form a lid of a container. The exemplary container articles in accordance with the disclosed subject matter configured to form a container lid, and the comparative injection molded articles having substantially similar size, shape, and construction but without flow leaders and configured to form a lid, each had a substantially circular shape in plan view and each had an interior volume of between approximately 10 ounces and approximately 11 ounces.

For purpose of comparison and with reference to FIG. 16A, the side wall panel thickness, side wall flow leader thickness, central flow leader thickness, and top load crush resistance was measured in ten exemplary container articles in accordance with the disclosed subject matter having a substantially circular shape and configured to form a container lid. The exemplary container articles in accordance with the disclosed subject matter tested had an average side wall panel thickness of approximately 13.5 mil. The exemplary container articles in accordance with the disclosed subject matter tested had an average top load crush resistance of approximately 170.5 lbf and an average weight of approximately 13.98 grams. Accordingly, the exemplary container articles in accordance with the disclosed subject matter had an average top load crush resistance strength to weight ratio of approximately 12.22

For purpose of comparison, and with reference to FIGS. 16B and 16C, the side wall thickness, center portion thickness, and top load crush resistance was measured in two types of comparative container articles having substantially similar size, shape, and construction but without flow leaders and configured to form a container lid: ten comparative articles of type A and ten comparative articles of type B, respectively. With reference to FIG. 16B, the type A comparative articles of substantially similar size, shape, and construction but without flow leaders had an average side wall thickness of approximately 22.2 mil and an average top load crush resistance of approximately 227.2 lbf. The type A comparative articles had an average weight of approximately 19.32 grams. Accordingly, the type A comparative articles of substantially similar size, shape, and construction but without flow leaders had an average top load crush resistance strength to weight ratio of approximately 11.76.

With reference to FIG. 16C, the type B comparative articles of substantially similar size, shape, and construction but without flow leaders are commercially available from Tripak with a product code of MT1710B. The type B comparative articles had an average side wall thickness of approximately 21.5 mil and an average top load crush resistance of approximately 223 lbf. The type B comparative articles had an average weight of approximately 19 grams. Accordingly, the type B comparative articles of substantially similar size, shape, and construction but without flow leaders had an average top load crush resistance strength to weight ratio of approximately 11.74.

For purpose of comparison, the exemplary container articles in accordance with the disclosed subject matter tested as summarized in FIG. 16A had a top load crush resistance strength to weight ratio of approximately 3% greater than the top load crush resistance strength to weight ratio of the type A comparative articles. The exemplary container articles in accordance with the disclosed subject matter tested as summarized in FIG. 16A had a top load crush resistance strength to weight ratio of approximately 4% greater than the top load crush resistance strength to weight ratio of the type B comparative articles. The exemplary container articles in accordance with the disclosed subject matter had a side wall panel thickness of approximately 39% less than the side wall thickness of the type A comparative articles and approximately 37% less than the side wall thickness of the type B comparative articles. Additionally, the exemplary container articles in accordance with the disclosed subject matter weighed approximately 27% less than the type A comparative articles and approximately 26% less than the type B comparative articles.

### Example 3

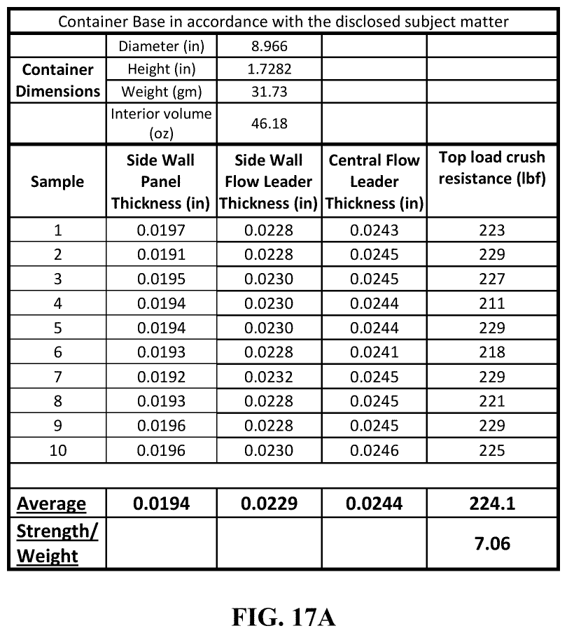

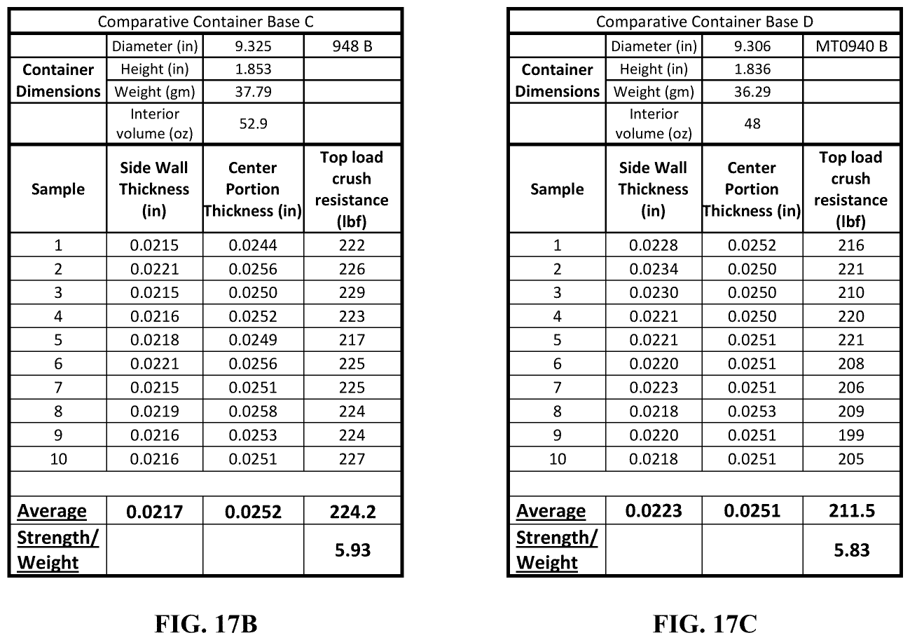

With reference to FIG. 17A-FIG. 17C, articles in accordance with the disclosed subject matter configured to form a base of a container were measured and compared to comparative injection molded articles having substantially similar size, shape, and construction, but without flow leaders, configured to form a base of a container. The exemplary container articles in accordance with the disclosed subject matter configured to form a container base, and the comparative injection molded articles having substantially similar size, shape, and construction but without flow leaders and configured to form a base, each had a substantially circular shape in plan view and each had an interior volume of between approximately 46 ounces and approximately 52 ounces.

For purpose of comparison and with reference to FIG. 17A, the side wall panel thickness, side wall flow leader thickness, central flow leader thickness, and top load crush resistance was measured in ten exemplary container articles in accordance with the disclosed subject matter having a substantially circular shape and configured to form a container base. The exemplary container articles in accordance with the disclosed subject matter tested had an average side wall panel thickness of approximately 19.4 mil. The exemplary container articles in accordance with the disclosed subject matter tested had an average top load crush resistance of approximately 224.1 lbf and an average weight of approximately 31.73 grams. Accordingly, the exemplary container articles in accordance with the disclosed subject matter had an average top load crush resistance strength to weight ratio of approximately 7.06

For purpose of comparison, and with reference to FIGS. 17B and 17C, the side wall thickness, center portion thickness, and top load crush resistance was measured in two types of comparative container articles having substantially similar size, shape, and construction but without flow leaders and configured to form a container base: ten comparative articles of type C and ten comparative articles of type D, respectively. With reference to FIG. 17B, the type C comparative articles of substantially similar size, shape, and construction but without flow leaders had an average side wall thickness of approximately 21.7 mil and an average top load crush resistance of approximately 224.2 lbf. The type C comparative articles had an average weight of approximately 37.79 grams. Accordingly, the type C comparative articles of substantially similar size, shape, and construction but without flow leaders had an average top load crush resistance strength to weight ratio of approximately 5.93.

With reference to FIG. 17C, the type D comparative articles of substantially similar size, shape, and construction but without flow leaders are commercially available from Tripak with a product code of MT0940B. The type D comparative articles had an average side wall thickness of approximately 22.3 mil and an average top load crush resistance of approximately 211.5 lbf. The type D comparative articles had an average weight of approximately 36.29 grams. Accordingly, the type D comparative articles of substantially similar size, shape, and construction but without flow leaders had an average top load crush resistance strength to weight ratio of approximately 5.83.

For purpose of comparison, the exemplary container articles in accordance with the disclosed subject matter tested as summarized in FIG. 17A had a top load crush resistance strength to weight ratio of approximately 20% greater than the top load crush resistance strength to weight ratio of the type C comparative articles. The exemplary container articles in accordance with the disclosed subject matter tested as summarized in FIG. 17A had a top load crush resistance strength to weight ratio of approximately 22% greater than the top load crush resistance strength to weight ratio of the type D comparative articles. The exemplary container articles in accordance with the disclosed subject matter had a side wall panel thickness of approximately 11% less than the side wall thickness of the type C comparative articles and approximately 13% less than the side wall thickness of the type D comparative articles. Additionally, the exemplary container articles in accordance with the disclosed subject matter weighed approximately 16% less than the type C comparative articles and approximately 12.5% less than the type D comparative articles.

### Example 4

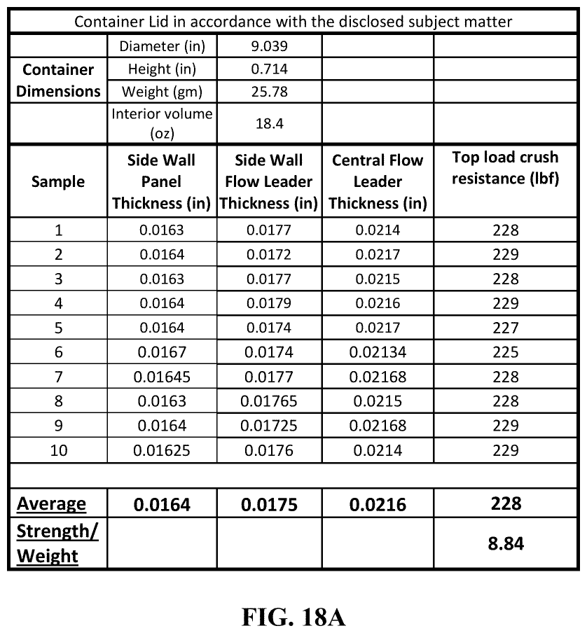

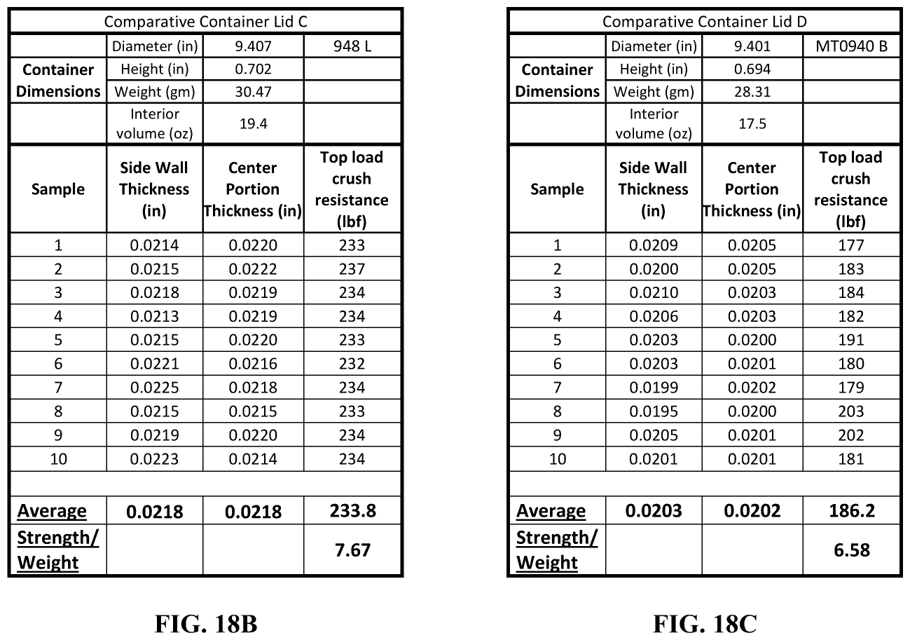

With reference to FIG. 18A-FIG. 18C, articles in accordance with the disclosed subject matter configured to form a lid of a container were measured and compared to comparative injection molded articles having substantially similar size, shape, and construction, but without flow leaders, configured to form a lid of a container. The exemplary container articles in accordance with the disclosed subject matter configured to form a container lid, and the comparative injection molded articles having substantially similar size, shape, and construction but without flow leaders and configured to form a lid, each had a substantially circular shape in plan view and each had an interior volume of between approximately 17.5 ounces and approximately 19.4 ounces.

For purpose of comparison and with reference to FIG. 18A, the side wall panel thickness, side wall flow leader thickness, central flow leader thickness, and top load crush resistance was measured in ten exemplary container articles in accordance with the disclosed subject matter having a substantially circular shape and configured to form a container lid. The exemplary container articles in accordance with the disclosed subject matter tested had an average side wall panel thickness of approximately 16.4 mil. The exemplary container articles in accordance with the disclosed subject matter tested had an average top load crush resistance of approximately 228 lbf and an average weight of approximately 25.78 grams. Accordingly, the exemplary container articles in accordance with the disclosed subject matter had an average top load crush resistance strength to weight ratio of approximately 8.84.

For purpose of comparison, and with reference to FIGS. 18B and 18C, the side wall thickness, center portion thickness, and top load crush resistance was measured in two types of comparative container articles having substantially similar size, shape, and construction but without flow leaders and configured to form a container lid: ten comparative articles of type C and ten comparative articles of type D, respectively. With reference to FIG. 18B, the type C comparative articles of substantially similar size, shape, and construction but without flow leaders had an average side wall thickness of approximately 21.8 mil and an average top load crush resistance of approximately 233.8 lbf. The type C comparative articles had an average weight of approximately 30.47 grams. Accordingly, the type C comparative articles of substantially similar size, shape, and construction but without flow leaders had an average top load crush resistance strength to weight ratio of approximately 7.67.

With reference to FIG. 18C, the type D comparative articles of substantially similar size, shape, and construction but without flow leaders are commercially available from Tripak with a product code of MT0940B. The type D comparative articles had an average side wall thickness of approximately 20.3 mil and an average top load crush resistance of approximately 186.2 lbf. The type D comparative articles had an average weight of approximately 28.31 grams. Accordingly, the type D comparative articles of substantially similar size, shape, and construction but without flow leaders had an average top load crush resistance strength to weight ratio of approximately 6.58.

For purpose of comparison, the exemplary container articles in accordance with the disclosed subject matter tested as summarized in FIG. 18A had a top load crush resistance strength to weight ratio of approximately 15.5% greater than the top load crush resistance strength to weight ratio of the type C comparative articles. The exemplary container articles in accordance with the disclosed subject matter tested as summarized in FIG. 18A had a top load crush resistance strength to weight ratio of approximately 33% greater than the top load crush resistance strength to weight ratio of the type D comparative articles. The exemplary container articles in accordance with the disclosed subject matter had a side wall panel thickness of approximately 25% less than the side wall thickness of the type C comparative articles and approximately 19% less than the side wall thickness of the type D comparative articles. Additionally, the exemplary container articles in accordance with the disclosed subject matter weighed approximately 15% less than the type C comparative articles and approximately 9% less than the type D comparative articles.

### Example 5

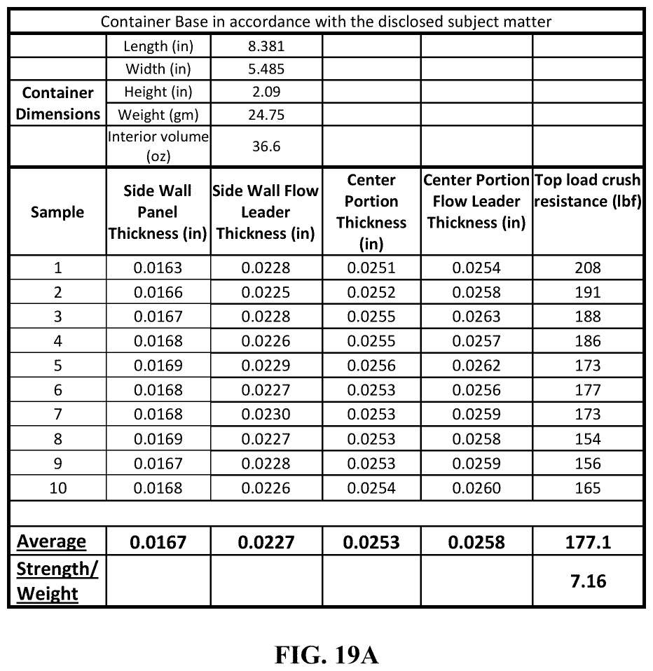

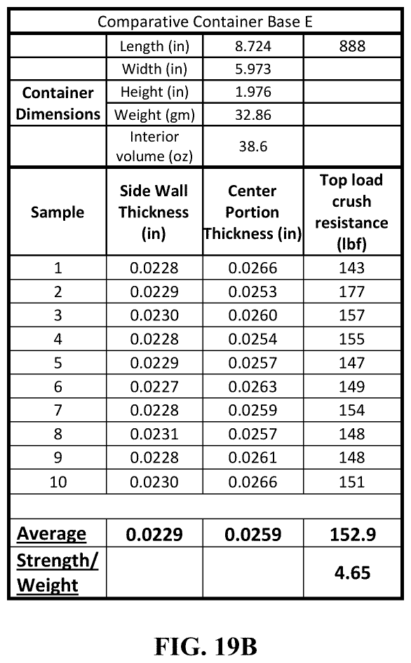

With reference to FIG. 19A-FIG. 19B, articles in accordance with the disclosed subject matter configured to form a base of a container were measured and compared to comparative injection molded articles having substantially similar size, shape, and construction, but without flow leaders, configured to form a base of a container. The exemplary container articles in accordance with the disclosed subject matter configured to form a container base, and the comparative injection molded articles having substantially similar size, shape, and construction but without flow leaders and configured to form a base, each had a substantially rectangular shape in plan view and each had an interior volume of between approximately 36.6 ounces and approximately 38.6 ounces.

For purpose of comparison and with reference to FIG. 19A, the side wall panel thickness, side wall flow leader thickness, center portion thickness, central flow leader thickness, and top load crush resistance was measured in ten exemplary container articles in accordance with the disclosed subject matter having a substantially rectangular shape and configured to form a container base. The exemplary container articles in accordance with the disclosed subject matter tested had an average side wall panel thickness of approximately 16.7 mil. The exemplary container articles in accordance with the disclosed subject matter tested had an average top load crush resistance of approximately 177.1 lbf and an average weight of approximately 24.75 grams. Accordingly, the exemplary container articles in accordance with the disclosed subject matter had an average top load crush resistance strength to weight ratio of approximately 7.16.

For purpose of comparison, and with reference to FIG. 19B, the side wall thickness, center portion thickness, and top load crush resistance was measured in ten comparative container articles having substantially similar size, shape, and construction but without flow leaders and configured to form a container base. With reference to FIG. 19B, the comparative articles of substantially similar size, shape, and construction but without flow leaders had an average side wall thickness of approximately 22.9 mil and an average top load crush resistance of approximately 152.9 lbf. The comparative articles had an average weight of approximately 32.86 grams. Accordingly, the comparative articles of substantially similar size, shape, and construction but without flow leaders had an average top load crush resistance strength to weight ratio of approximately 4.65.

For purpose of comparison, the exemplary container articles in accordance with the disclosed subject matter tested as summarized in FIG. 19A had a top load crush resistance strength to weight ratio of approximately 53% greater than the top load crush resistance strength to weight ratio of the comparative articles. The exemplary container articles in accordance with the disclosed subject matter had a side wall panel thickness of approximately 27% less than the side wall thickness of the comparative articles. Additionally, the exemplary container articles in accordance with the disclosed subject matter weighed approximately 25% less than the comparative articles.

### Example 6

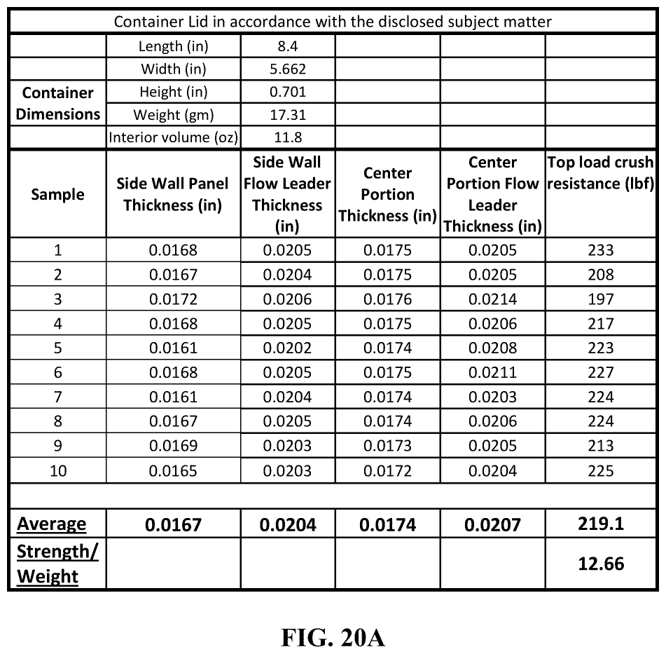

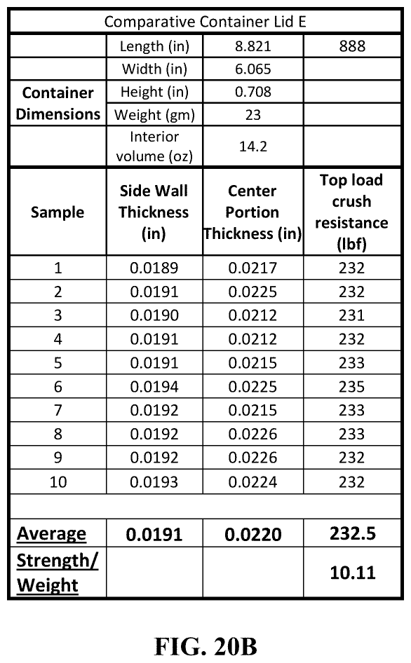

With reference to FIG. 20A-FIG. 20B, articles in accordance with the disclosed subject matter configured to form a lid of a container were measured and compared to comparative injection molded articles having substantially similar size, shape, and construction, but without flow leaders, configured to form a lid of a container. The exemplary container articles in accordance with the disclosed subject matter configured to form a container base, and the comparative injection molded articles having substantially similar size, shape, and construction but without flow leaders and configured to form a lid, each had a substantially rectangular shape in plan view and each had an interior volume of between approximately 11.8 ounces and approximately 14.2 ounces.

For purpose of comparison and with reference to FIG. 20A, the side wall panel thickness, side wall flow leader thickness, center portion thickness, central flow leader thickness, and top load crush resistance was measured in ten exemplary container articles in accordance with the disclosed subject matter having a substantially rectangular shape and configured to form a container lid. The exemplary container articles in accordance with the disclosed subject matter tested had an average side wall panel thickness of approximately 16.7 mil. The exemplary container articles in accordance with the disclosed subject matter tested had an average top load crush resistance of approximately 219.1 lbf and an average weight of approximately 17.3 grams. Accordingly, the exemplary container articles in accordance with the disclosed subject matter had an average top load crush resistance strength to weight ratio of approximately 12.66.

For purpose of comparison, and with reference to FIG. 20B, the side wall thickness, center portion thickness, and top load crush resistance was measured in ten comparative container articles having substantially similar size, shape, and construction but without flow leaders and configured to form a container lid. With reference to FIG. 20B, the comparative articles of substantially similar size, shape, and construction but without flow leaders had an average side wall thickness of approximately 19.1 mil and an average top load crush resistance of approximately 232.5 lbf. The comparative articles had an average weight of approximately 23 grams. Accordingly, the comparative articles of substantially similar size, shape, and construction but without flow leaders had an average top load crush resistance strength to weight ratio of approximately 10.1.

For purpose of comparison, the exemplary container articles in accordance with the disclosed subject matter tested as summarized in FIG. 19A had a top load crush resistance strength to weight ratio of approximately 26% greater than the top load crush resistance strength to weight ratio of the comparative articles. The exemplary container articles in accordance with the disclosed subject matter had a side wall panel thickness of approximately 13% less than the side wall thickness of the comparative articles. Additionally, the exemplary container articles in accordance with the disclosed subject matter weighed approximately 25% less than the comparative articles.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. An injection molded container article comprising:
a center portion having an outer perimeter, the center portion having a central flow leader defined therein, the central flow leader having a central flow leader thickness, and
a side wall portion extending from the outer perimeter of the center portion to an outer rim portion, the center portion and the side wall portion together defining a container space having a volume,
wherein the side wall portion includes a plurality of side wall flow leaders and a plurality of side wall panels, each side wall panel extending between adjacent side wall flow leaders and having a side wall panel thickness less than the central flow leader thickness, each side wall flow leader having a side wall flow leader thickness greater than the side wall panel thickness, each side wall flow leader extending between the central flow leader and the outer rim portion.

2. The injection molded container article of claim 1, wherein the central flow leader, the plurality of side wall flow leaders, and the outer rim portion are interconnected to define a support framework.

3. The injection molded container article of claim 1, wherein the side wall portion includes a radiused transition in side cross-section extending from the outer perimeter of the center portion.

4. The injection molded container article of claim 1, wherein the plurality of side wall flow leaders extend into the center portion.

5. The injection molded container article of claim 1, wherein the plurality of side wall flow leaders are spaced from one another about the side wall portion.

6. The injection molded container article of claim 1, wherein the side wall portion includes four radiused corners with opposing side walls therebetween to define a substantially rectangular shape in plan view.

7. The injection molded container article of claim 6, wherein the radiused corners have a radius in plan view between approximately 0.38 inches and approximately 1.15 inches.

8. The injection molded container article of claim 6, wherein the plurality of side wall flow leaders include a flow leader defined within each radiused corner of the side wall portion.

9. The injection molded container article of claim 6, wherein the plurality of side wall flow leaders include opposing flow leaders in a respective pair of the opposing side walls of the side wall portion.

10. The injection molded container article of claim 9, wherein the opposing flow leaders are located at respective midpoints along the pair of opposing side walls.

11. The injection molded container article of claim 9, wherein the side wall portion includes opposing long side walls and opposing short side walls, and the opposing flow leaders are located at midpoints of the opposing short side walls.

12. The injection molded container article of claim 1, wherein at least one side wall flow leader has a first width proximate the central flow leader and second width proximate the outer rim, the first width less than the second width.

13. The injection molded container article of claim 1, wherein the outer rim portion has an outer rim thickness greater than the side wall panel thickness.

14. The injection molded container article of claim 1, wherein the center portion defines a horizontal support surface of a container base, the side wall portion extending upwardly from the perimeter of the center portion to the outer rim portion.

15. The injection molded container article of claim 14, wherein the side wall portion includes a radiused transition portion in side cross-section extending upwardly from the outer perimeter of the center portion, and further wherein at least a portion of the side wall extends upwardly from the radiused transition portion to define a convex surface in side cross-section relative to the container space, the radiused transition and the convex surface defining a sinusoid when viewed in cross-section.

16. The injection molded container article of claim 15, wherein the side wall portion includes opposing long side walls and opposing short side walls to define a substantially rectangular shape with the convex surfaces located on the opposing long side walls.

17. The injection molded container article of claim 14, further comprising a lid having a lid rim portion, wherein the outer rim portion is engageable with the lid rim portion in a closed position.

18. The injection molded container article of claim 17, wherein the lid further comprises a lid side wall portion extending from the lid rim portion and including a plurality of flow leaders defined therein.

19. The injection molded container article of claim 1, wherein the center portion defines an upper surface of a lid with the side wall portion extending downwardly from the perimeter of the center portion to the outer rim portion.

20. The injection molded container article of claim 19, wherein the outer rim portion defines a fastener.

21. The injection molded container article of claim 19, wherein the lid includes a channel between the side wall portion and the outer rim portion.

22. The injection molded container article of claim 21, further comprising a plurality of ribs extending across the channel between the side wall portion and the outer rim.

23. The injection molded container article of claim 22, wherein the plurality of ribs are aligned with the plurality of side wall flow leaders.

24. The injection molded container article of claim 1, wherein the side wall portion has a substantially circular shape in plan view.

25. The injection molded container article of claim 24, wherein the plurality of side wall flow leaders are equally spaced from one another about the side wall portion.

26. The injection molded container article of claim 1, wherein at least one side wall flow leader has a first width proximate the central flow leader and a second width proximate the outer rim portion with an intermediate flow leader width therebetween, wherein the intermediate width is less than the first and second flow leader widths.

27. The injection molded container article of claim 25, wherein the at least one side wall flow leader defines an hourglass shape in plan view.

28. The injection molded container article of claim 1, wherein the side wall panel thickness is between approximately 12 mil and approximately 18 mil.

29. The injection molded container article of claim 1, wherein the side wall flow leader thickness is between approximately 15 mil and approximately 23 mil.

30. The injection molded container article of claim 1, wherein a ratio between the side wall panel thickness and the flow leader thickness is between approximately 1:1.25 and approximately 1:1.28.

31. The injection molded container article of claim 1, wherein the injection molded container article has a top load crush resistance strength to weight ratio equal to or greater than a top load crush resistance strength to weight ratio of a comparative injection molded article having a substantially similar size, shape and construction as the injection molded container article but without any flow leaders.

32. The injection molded container article of claim 30, wherein the injection molded container article has a side wall panel thickness between approximately 5 percent to approximately 30 percent less than the side wall thickness of the comparative injection molded article.

33. The injection molded container article of claim 30, wherein the injection molded container article has a side wall panel thickness between approximately 25 percent to approximately 50 percent less than the side wall thickness of the comparative injection molded article.

34. The injection molded container article of claim 30, wherein the injection molded container article weighs between approximately 10 percent to approximately 30 percent less than the comparative injection molded article weighs.

35. The injection molded container article of claim 1, wherein the article has a top load crush resistance of between approximately 125 lbf and approximately 250 lbf.

36. A method of making an injection molded container article comprising:
providing a mold configured to form a container article comprising
a center portion having an outer perimeter the center portion having a central flow leader defined therein, the central flow leader having a central flow leader thickness, and
a side wall portion extending from the outer perimeter of the center portion to an outer rim portion, the center portion and the side wall portion together defining a container space having a volume,
wherein the side wall portion includes a plurality of side wall flow leaders and a plurality of side wall panels, each side wall panel extending between adjacent side wall flow leaders and having a side wall panel thickness less than the central flow leader thickness, each side wall flow leader having a side wall flow leader thickness greater than the side wall panel thickness, and each side wall flow leader extending between and in fluid communication with the central flow leader and the outer rim portion; and
injecting molten material into the mold proximate the central flow leader, whereby the molten material is first directed from the central flow leader along the plurality of side wall flow leaders to fill the outer rim portion, and whereby the molten material backfills the plurality of side wall panels between the plurality of side wall flow leaders.
